(19) United States
(12) Patent Application Publication
(10) Pub. No.: US 2004/0118839 A1
(43) Pub. Date: Jun. 24, 2004

(54) Package

(75) Inventors: John Michael Hughes, Goshen, NY (US); Sheila Wenke, Chestnut Ridge, NY (US)

Correspondence Address: UNILEVER, PATENT DEPARTMENT, 45 RIVER ROAD, EDGEWATER, NJ, 07020, US

(73) Assignee: Unilever Bestfoods, North America, Division of Conopco, Inc.

(21) Appl. No.: 10/328,220

(22) Filed: Dec. 23, 2002

(51) Int. Cl. H05B 6/80

(52) U.S. Cl. 219/734; 219/725

(57) ABSTRACT

An easy-opening microwavable food package which can be used both to cook and serve the food. It is easily opened and yet convenient as a vehicle for eating, so as to avoid the necessity for separate dishes which will need to be washed. The package is designed to permit venting of the package during cooking while minimizing the possibility for a messy and inadvertent escape of product onto, for example, the floor and walls of the microwave. The package comprises a first tear facilitator for removing the top end of the package for venting and a second tear facilitator for removing a further section of the side wall. The second tear facilitator promotes tearing of the side wall at a point spaced from and below the tear promoted by the first tear facilitator and serves to enhance access to the food for eating. The tear facilitators may, e.g., comprise pairs of notches in the walls of the package.

### BACKGROUND OF THE INVENTION

The amount of time available for preparation of meals has been steadily diminishing in recent years. Microwave cooking has been embraced by many consumers as one solution to the problem of dwindling meal preparation time. Microwave cooking often demands less attention than conventional oven cooking and is usually completed in a shorter period of time.

But it is not enough merely to shorten the amount of time which must be devoted to cooking. For instance, while the busy executive who arrives home late at night wants to reduce meal preparation time, he or she would also prefer not to have to expend effort washing dishes at the completion of the meal, to the extent that this can be avoided.

Use of the microwave is not limited to busy young executives and parents in hectic households. Older consumers also find the convenience of microwave beneficial. However, older consumer sometimes lack the dexterity possessed by their younger counterparts. For that reason, microwave packaging is desirably easily opened.

There is a need, therefore, for microwave packaging which can meet a variety of consumer desiderata, including easy opening and minimization of time spent dishwashing.

Numerous microwavable containers have been disclosed over the years.

Johnson et al. EP 823 388 (Kraft) discloses a stand up pouch for a microwavable food entree. Notch 23 may be included to facilitate initiation of the opening procedure. Line of weakening 24 may also be included.

Chow et al. U.S. Published patent application No. 2002/0068668 discloses a method for producing an easy open, easy tear package using a laser. A microprocessor modulates the laser to create tear initiation areas along a score line. For instance, FIG. 4 illustrates a score line extending from a top edge of a package to a side edge, the top edge of the score line having cut through areas and the side edge having a highly damaged area. Tearing may be initiated at cut through or highly damaged areas. In another embodiment, Chow et al. use a pair of score lines each having a cut out area at each end.

Tang U.S. Published patent application No. 2002/0001645 is directed in FIG. 12 to a package made from an ACE sheet and an inner layer. The ACE sheet has nicks of each of two lines of weakness to permit sequential opening of three compartments. FIG. 13 is similar except that 3 pairs of lines of weakness are used, each pair of which traverses three compartments. In the embodiment of FIG. 9j, prior to microwave cooking, the consumer tears the bag open along lines of weakness 34 to create a small opening allowing partial release of gas vapor during cooking. Following microwave cooking, the bag may be opened using further aligned lines of weakness 45. The further aligned lines of weakness 45 may extend substantially parallel to the lines 34, no greater than 15 mm apart.

Igota et al U.S. Pat. No. 6,121,597 discloses a notched bag for microwave ovens capable of allowing escape of vapor generated during microwave heating.

Mast U.S. Pat, No. 6,054,698, EP 839 737, and Childress U.S. Pat. No. 5,919,390, disclose microwave packages having a notch.

Other microwave bags are disclosed in, for example, Walters et al. U.S. Pat. No. 5,489,766.

### SUMMARY OF THE INVENTION

The present invention is directed to a new microwavable package which is easily opened and yet convenient as a vehicle for eating, so as to avoid the need for separate dishes which will need to be washed. Consumption of food directly from the package also avoids the need for transferring food from the package to the plate, further enhancing the convenience of microwaving. The package is designed to permit venting of the package during cooking while minimizing the possibility for a messy and inadvertent escape of product onto, for example, the floor and walls of the microwave.

The package comprises a bottom end and a top end and first and a side wall ends extending between the bottom and top ends. A first tear facilitator for removing the top end facilitates tearing of at least a portion of the circumference of the side wall. Removal of the top end assists cooking of the package contents by permitting release of pressure accumulated within the package due to elevated temperatures. However, after the original top end is torn off, there is sufficient room between the opening at the torn top end and the food contained within the package such that the chances of spattering of the product during cooking are minimized. In accordance with one aspect of the invention, a second tear facilitator is present for removing a further section of the side wall. The second tear facilitator promotes tearing of the side wall at a point spaced from and below the tear promoted by the first tear facilitator and serves to enhance access to the food for eating. That is, the second tear facilitator permits enough of the side wall to be removed such that the consumer can very easily reach the food within the package. If the second tear facilitator were used at the outset prior to cooking to create the vent opening, there would be a strong danger of food splattering onto the microwave floor and/or walls.

Since a purpose of the dual tear facilitators is to permit the food to be cooked with a higher side wall than will be present when it is eaten, there will generally be a substantial vertical distance between the tear facilitators, preferably at least one inch, especially at least one and one half inches, more preferably at least 1.5, two, 2.5 or three inches.

In accordance with a preferred aspect of the invention, the first and second tear facilitators each comprises a pair of areas of weakness, one member of each pair being disposed at first and second side wall ends. In accordance with a further preferred aspect of the invention, the first and second tear facilitators each comprises a pair of notches, one member of each pair being disposed at the first and second side wall ends.

First and second side wall ends mentioned herein would encompass various points on side walls on packages having a variety of cross sectional shapes, e.g., rectangular, circular, oval, etc. For example the first and second side wall ends may comprise opposing points on packages with a variety of cross sectional shapes, e.g., rectangular, circular, oval, etc. The important thing is that the tear facilitators promote tearing of the side wall at adequate heights and to sufficient extents that the goals of 1) venting without spilling and 2) eating without having to reach deep within a package are both achieved. Preferably the first and second tear facilitators promote tearing of the entire circumference of the side wall of the package.

Other specific forms of tear facilitator can be envisaged, e.g., laser scoring, perforated lines and ways of creating weakness in the side walls.

Preferably, the package is a microwavable stand up package which, when food is contained therein, can be rested on a tabletop or other flat surface with the opening at the top. Typically the package will be a flexible package comprised of a lamination containing polyethylene, polypropylene, polyester and/or nylon.

For a more complete understanding of the above and other features and advantages of the invention, reference should be made to the following detailed description of preferred embodiments and the accompanying drawings.

### BRIEF DESCRIPTION OF THE DRAWINGS

FIG. 1 is a cross sectional view of a bag, prior to sealing, which can be used in the present invention.

### DETAILED DESCRIPTION OF THE INVENTION

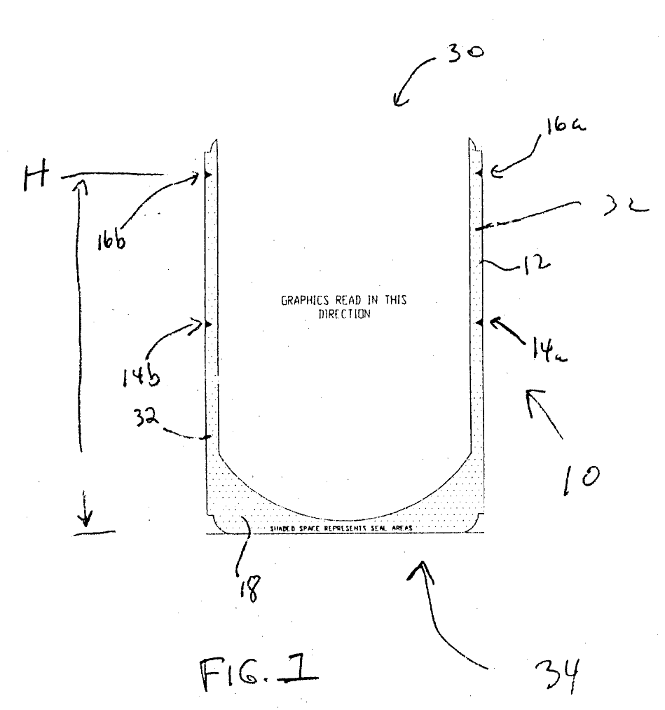

The package of the invention will generally be made of flexible packaging, e.g., thermoplastic, and will typically take the form of a bag or pouch. The package material may, for instance, be a reverse printed multi-layer lamination such as one comprising a layer of polyester and a layer of polypropylene. Prior to filling, the pouch 10 is typically open only at the top end 30 for filling, as seen in FIG. 1. The pouch of FIG. 1 is prepared by placing two layers of the packaging lamination one atop the other, or folding a single layer, and sealing along the sides to provide sealing margins 32 and along the bottom end 34 to provide sealing margin 18. Areas of sealing prior to filling of the pouch are shown by shading in FIG. 1. Bottom 34 is preferably provided with a gusset or other arrangement at bottom end 34 to promote standing up of the pouch when it is filled with food, as is known in the art. In this way, once the package has been filled, it can be rested with the food at the bottom with upper end 30 appropriately oriented.

Side sealing areas 32 are provided with notches to facilitate opening of the pouch. A first pair of notches, 16a, 16b is disposed near upper end 30. A second pair of notches 14a, 14b is disposed spaced downwardly from the first pair. After the pouch 10 is filled with microwavable food product, it is sealed along the upper edges of the sheets at upper end 30 of the pouch.

In use, when the consumer is ready to microwave the product, he tears the pouch at notches 16a, 16b, preferably removing the entire upper end of the pouch. This permits the bag to vent while it is being microwaved. The height H of the pouch at the upper notches 16a, 16b minimizes the likelihood that product will escape during microwave cooking. When cooking is completed, the pouch is removed from the microwave and then the pouch is torn along the second set of notches, 14a, 14b. This provides the consumer with ready access to food within the stand up pouch, so that with an optional eating utensil, he can proceed readily to consume the food. If the upper portion of the side wall had not been removed, the consumer would likely soil his hands and clothing by contact with the wall of the pouch when reaching in to access the food.

The notches are preferably pre-cut into the side seals of the stand-up pouch.

Sealing may be effected, for example, by heat sealing.

It should be understood, of course, that the specific forms of the invention herein illustrated and described are intended to be representative only as certain changes may be made therein without departing from the clear teachings of the disclosure. Accordingly, reference should be made to the following appended claims in determining the full scope of the invention.

What is claimed is:

1. A package for food comprising a bottom end and a top end, a side wall extending between said bottom and top ends, a first tear facilitator for removing at least a portion of said top end by facilitating tearing at least a portion of said side wall for cooking said package and a second tear facilitator for removing a further section of said side wall by tearing at least a portion of the circumference of said side wall to facilitate eating of said food, said first and second tear facilitators being spaced from each other by at least one and one-half inches, said second tear facilitator being below the first.

2. The package according to claim 1 wherein said first and second tear facilitators are spaced from each other by at least 2½ inches.

3. The package according to claim 2 wherein said first and second tear facilitators are spaced from each other by at least three inches.

4. The package according to claim 1 wherein the first and second tear facilitators each comprises a pair of areas of weakness, one member of each pair being disposed at first and second side wall ends.

5. The package according to claim 4 wherein said first and second tear facilitators each comprises a pair of notches, one member of each pair being disposed at said first and second side wall ends.

6. The package according to claim 1 wherein said package contains food and rests on said bottom end.

7. The package according to claim 1 wherein it is made of a material which is microwavable.
